(19) United States
(12) Patent Application Publication
(10) Pub. No.: US 2023/0079806 A1
(43) Pub. Date: Mar. 16, 2023

(54) IDENTIFIER SETTING SYSTEM

(71) Applicant: Prime Planet Energy & Solutions, Inc., Tokyo (JP)

(72) Inventors: Atsushi HIRAYAMA, Suita-shi (JP); Tomonori KAWAMOTO, Takasago-shi (JP)

(21) Appl. No.: 17/930,068

(22) Filed: Sep. 7, 2022

(30) Foreign Application Priority Data
Sep. 10, 2021 (JP) 2021-147706

(51) Int. Cl. G05B 15/02

(52) U.S. Cl. CPC G05B 15/02

(57) ABSTRACT

An identifier setting system disclosed herein includes a plurality of control devices, a communication line, and an activation line. In a case where an identifier setting section of a control device, which is one of the plurality of control devices, determines that an identifier of the control device is not set, a monitoring section acquires identifiers output from the plurality of control devices, and an activation control section controls the activation line so as to stop another control device, which does not output the identifier. The identifier setting section sets an identifier different from the identifiers acquired by the monitoring section as the identifier of the control device. The activation control section controls the activation line so as to activate the other control device, which does not output the identifier.

### CROSS REFERENCE TO RELATED APPLICATIONS

The present application claims priority from Japanese Patent Application No. 2021-147706 filed on Sep. 10, 2021, which is incorporated by reference herein in its entirety.

### BACKGROUND

A technique disclosed herein relates to an identifier setting system.

In a communication system disclosed in WO 2012/131797, a master device and a plurality of slave devices are connected by controller area network (CAN) communication, and the individual slave devices are also connected by a communication line for setting an identifier. The master device transmits an ID setting signal to the slave device via the CAN communication, and the slave device having received the ID setting signal stores an ID (identifier) based on the ID setting signal. Then, the slave device having received the ID setting signal outputs the ID setting signal to the subsequent slave device, and the slave device having received the ID setting signal stores the ID transmitted from the master device. A method of setting the identifier by such a method is disclosed.

### SUMMARY

Incidentally, in a plurality of slave devices (e.g., control devices) described above, in a case where part of the slave devices is replaced because of a failure or the like, it is necessary to set (reset) an identifier in the slave device after replacement. While it is possible to perform setting of the identifier manually by, for instance, a manager of a communication system, in the case where a plurality of the slave devices are replaced, a procedure of setting change is complicated, and a replacement operation may take a long period of time. Consequently, identifier setting at the time of the replacement of the slave device is preferably performed automatically in a short period of time.

However, according to the method described in WO 2012/131797, it is necessary to transmit a command a plurality of times from a master device to individual slave devices, and hence, in a case where there are many slave devices in which the identifiers need to be set, setting time of the identifier is increased. Further, the individual slave devices need to be connected to each other by a communication line in addition to CAN communication connection and, as a result, the number of components is increased and cost is thereby increased or a size of a system tends to be increased.

A technique disclosed herein has been devised in order to solve such a problem, and an object thereof is to provide an identifier setting system for setting unique identifiers for a plurality of control devices by a simple method.

In order to solve the above problem, the following identifier setting system is provided by the technique disclosed herein. An identifier setting system disclosed herein includes a plurality of control devices, a communication line which connects the plurality of control devices such that the plurality of control devices can communicate with each other, and an activation line which connects the plurality of control devices such that activations of the plurality of control devices can be mutually controlled. Each of the plurality of control devices includes a communication section which is configured to be able to communicate with the communication line, a monitoring section which monitors the communication line, an identifier setting section which sets an identifier, and an activation control section which controls the activation of the control device. Herein, in a case where the identifier setting section of a control device, which is one of the plurality of control devices, determines that an identifier of the control device is not set, the monitoring section monitors the communication line for a predetermined period of time to acquire identifiers output from the plurality of control devices, and the activation control section controls the activation line so as to stop another control device, which does not output the identifier. The identifier setting section sets an identifier different from the identifiers acquired by the monitoring section by monitoring the communication line for the predetermined period of time as the identifier of the control device. The activation control section controls the activation line so as to activate the other control device, which does not output the identifier.

In the identifier setting system having the above-described configuration, in the case where the identifier is not set in the control device which is one of the plurality of control devices, the other control device which does not transmit the identifier is temporarily stopped. With this, it is possible to prevent identifier setting processing from being executed concurrently in the plurality of control devices and prevent setting of a duplicate identifier in the identifier setting system. That is, it is possible to set unique identifiers for the plurality of control devices by a simple method. In addition, while the identifier setting processing is executed in the control device which is one of the plurality of control devices, the other control device in which the identifier is not set is stopped, and hence it is possible to save power consumption.

In an aspect of the identifier setting system disclosed herein, in a case where the identifier setting section of the control device, which is one of the plurality of control devices, determines that the identifier of the control device is already set, the identifier setting section outputs the identifier of the control device to the communication line. The activation control section controls the activation line so as to activate the other control device, which is one of the plurality of control devices.

According to such a configuration, it is possible to set unique identifiers by a simple method more preferably.

### BRIEF DESCRIPTION OF THE DRAWINGS

FIG. 1 is a block diagram schematically showing an example of a configuration of a battery system according to an embodiment;

FIG. 2 is a block diagram schematically showing an arithmetic processing unit according to the embodiment;

FIG. 3 is a flowchart showing an identifier setting processing method according to the embodiment; and

FIGS. 4A and 4B are schematic views showing an example of replacement of battery modules of the battery system shown in FIG. 1, and FIG. 4A shows a state in which the battery modules are detached for replacement and FIG. 4B shows a state in which the battery modules are installed for replacement.

### DETAILED DESCRIPTION

Hereinbelow, an embodiment of an identifier setting system proposed herein will be described. It goes without saying that the embodiment described herein is not intended to particularly limit the present disclosure. Note that, apart from matters which are specifically mentioned in the present specification, other matters which are necessary for implementation can be understood as design matters of those skilled in the art based on the conventional art in the field. The present disclosure can be implemented based on contents disclosed in the present specification and common general technical knowledge in the field. Note that, in the following drawings, members and portions which have the same functions are designated by the same reference numerals and are described. Further, dimensional relationships in the individual drawings may not necessarily reflect actual dimensional relationships.

As one of embodiments of the identifier setting system disclosed herein, a battery system including a plurality of battery modules will be described in detail with reference to the drawings. However, it is not intended to limit an application target of the identifier setting system disclosed herein to such a battery system.

Such a battery system can be used as an on-vehicle power supply used in an electric vehicle or the like. In addition, the battery system can also be used as a power storage device including a plurality of chargeable and dischargeable cells.

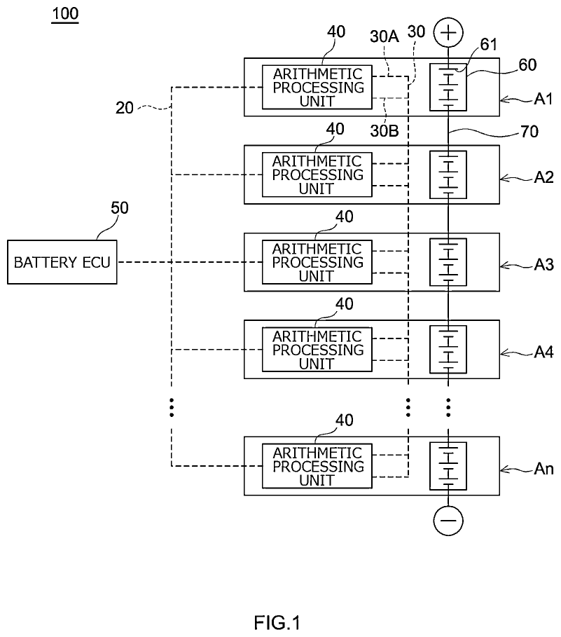

FIG. 1 is a view showing a schematic configuration of a battery system 100. With reference to FIG. 1, an overall configuration of the battery system 100 in the present embodiment will be schematically described. The battery system 100 includes a plurality of battery modules A1 to An, a communication line 20 which connects the plurality of battery modules A1 to An such that the plurality of battery modules A1 to An can communicate with each other, and an activation control lines 30 which is connected to the plurality of battery modules A1 to An. The plurality of battery modules A1 to An can mutually control activations of arithmetic processing units 40 via the activation control line 30. Herein, the communication line 20 is an example of a communication line, and the activation control line 30 is an example of an activation line. Further, in addition to the plurality of battery modules A1 to An, the communication line 20, and the activation control line 30, the battery system 100 includes a battery electrical control unit (ECU) 50 which manages the plurality of battery modules A1 to An. Note that the battery ECU 50 is not essential, and can be omitted in other embodiments.

The battery system 100 includes the plurality of (n pieces: n≥2, herein, n is an integer) of battery modules (A1, A2, A3 . . . , An). In FIG. 1, for the sake of convenience, of n battery modules, only five battery modules A1, A2, A3, A4, and An are shown in the drawing. Each battery nodule includes a cell group 60 including a plurality of cells 61, and the arithmetic processing unit 40. Herein, the arithmetic processing units 40 of the plurality of battery modules A1 to An are an example of a plurality of control devices.

The cell group 60 includes at least one cell 61. In the cell group 60 of the present embodiment, a plurality of the cells 61 are provided. As the cell 61, it is possible to use, e.g., various secondary batteries (e.g., a nickel metal hydride battery, a lithium ion battery, and a nickel-cadmium battery). For example, as shown in FIG. 1, a plurality of the cell groups 60 are connected in series via wiring 70. Although not shown in the drawing, the cell groups 60 can perform charge and discharge by being connected to an external load (or a charging device) of the battery system 100 via an external terminal. Note that, in the wiring 70 in FIG. 1, the cell groups 60 are connected in series, but the cell groups 60 may also be connected in parallel.

Although not shown in the drawing, a voltage detection section and a temperature detection section are mounted to the cell group 60. The voltage detection section detects a voltage of the cell 61 (in the present embodiment, a plurality of the cells 61 which are connected in series) of the cell group 60. The temperature detection section detects a temperature of the cell 61 of the cell group 60 or a temperature of a vicinity of the cell 61. As the temperature detection section, it is possible to use various elements (e.g., a thermistor and the like) for detecting temperature. A state of the cell group 60 acquired herein can be transmitted to the battery ECU 50 via the communication line 20 together with, e.g., a set identifier of the arithmetic processing unit 40.

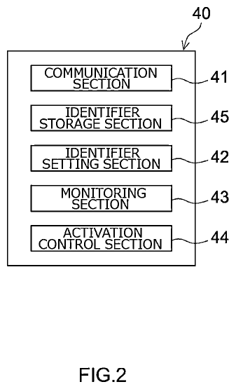

As shown in FIG. 2, the arithmetic processing unit 40 disclosed herein includes a communication section 41, an identifier setting section 42, a monitoring section 43, and an activation control section 44. The arithmetic processing unit 40 includes an identifier storage section 45 in addition to the individual sections 41 to 44.

The arithmetic processing unit 40 is typically constituted by a microcomputer. A configuration of hardware of the microcomputer is not particularly limited. For example, the microcomputer includes an interface (I/F) which receives data or the like from external equipment such as a host computer, a central processing unit (CPU) which performs arithmetic calculation according to a predetermined program, a ROM in which a program executed by the CPU is stored, a RAM which is used as a working area into which a program is loaded, and a storage device (storage medium) such as a memory in which the program and various pieces of data are stored. Individual functions of the arithmetic processing unit 40 can be implemented by cooperation between a computer which executes a predetermined program and hardware. The arithmetic processing unit 40 performs predetermined arithmetic processing according to a predetermined program, and sets an identifier from an arithmetic processing result. The identifier of the arithmetic processing unit 40 set by identifier setting processing is stored in the identifier storage section 45. Herein, the identifier storage section 45 is a non-volatile memory.

The arithmetic processing unit 40 is connected to the communication line 20 (see FIG. 1) via the communication section 41. The individual battery modules A1 to An are connected to each other so as to be able to communicate with each other via the communication line (controller area network: CAN). In addition, the individual battery modules A1 to An are connected to the battery ECU 50 by line connection via the communication line 20. The individual modules A1 to An are connected to each other so as to be able to transmit and receive various signals via the communication line 20. Further, the individual battery modules A1 to An and the battery ECU 50 are connected such that various signals can be transmitted and received via the communication line 20 between the individual battery modules A1 to An and the battery ECU 50.

As shown in FIG. 1, the arithmetic processing unit 40 of the battery module A1 is connected to the arithmetic processing units 40 of the battery module A2 and the battery module A3 via the activation control line 30. In addition, similarly, the arithmetic processing unit 40 of the battery module A2 is also connected to the arithmetic processing units 40 of the battery module A1 and the battery module A3 via the activation control line 30. To each arithmetic processing unit 40, an IG (ignition) signal ON or an IG signal OFF is input via an activation control line 30A. In addition, each arithmetic processing unit 40 (more specifically, the activation control section 44) can output the IG signal ON or the IG signal OFF to an activation control line 30B. Herein, the IG signal is a binary signal representing two states which are ON and OFF. In the case where the IG signal ON is input via the activation control line 30A, the arithmetic processing unit 40 starts the identifier setting processing described later. On the other hand, in the case where the IG signal OFF is input via the activation control line 30A, the arithmetic processing unit 40 stops the identifier setting processing. In the system disclosed herein, the activation control section 44 of the arithmetic processing unit 40 can output the IG signal ON or the IG signal OFF via the activation control line 30B. That is, the activation control section 44 of each of the battery modules A1 to An is configured to be able to perform control such that the identifier setting processing in each of the other arithmetic processing units 40 having the same configuration is started or stopped by outputting the IG signal ON or the IG signal OFF to the activation control line 30B.

The identifier setting section 42 sets the identifier of the arithmetic processing unit 40. The identifier setting section 42 is configured such that, as a result of monitoring the communication line 20 for a predetermined time period by the monitoring section 43 described later, the identifier setting section 42 sets, as an identifier of the arithmetic processing unit 40, an identifier which does not overlap, among identifiers of a plurality of the battery modules, identifiers of the other battery modules. The set identifier of the arithmetic processing unit 40 is transmitted to each of the other battery modules at regular time intervals as transmission CANID via the communication line 20. The time interval is, e.g., 100 milliseconds. Note that details of a control method in the identifier setting section 42 will be described later.

The monitoring section 43 monitors the communication line 20 for the predetermined time period, and acquires identifiers transmitted from, among a plurality of the battery modules, the other battery modules. As described above, the identifier set as the identifier of the arithmetic processing unit 40 is transmitted at regular time intervals. The predetermined time period in which the monitoring section 43 monitors the communication line 20 only needs to be longer than a time interval at which the other battery modules communicate identifiers, and it is possible to adjust the predetermined time period appropriately.

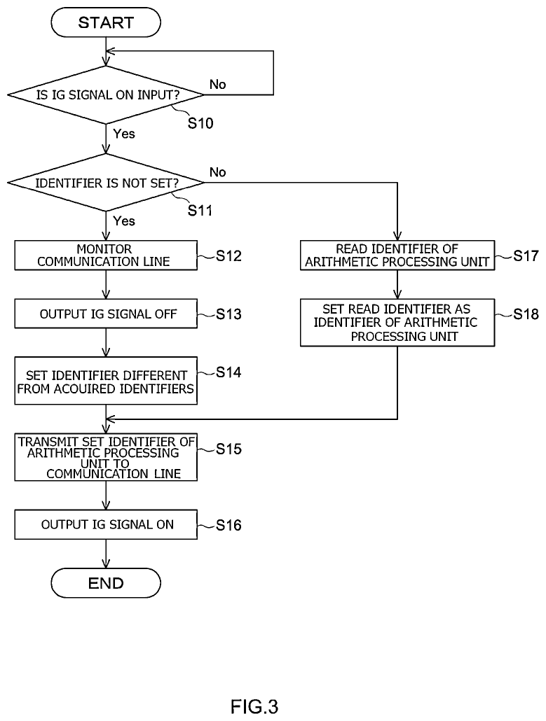

Next, a description will be given of an identifier setting method which uses the battery system 100 described above. FIG. 3 is a view showing a procedure of the identifier setting processing of the battery system 100.

Herein, the identifier setting method disclosed herein will be described by using, as an example, the case where, among the battery modules A1 to An of the battery system 100, the battery module A3 is replaced with a battery module A3′ and the battery module A4 is replaced with a battery module A4′. However, a mode to which the identifier setting method is applied is not limited to this mode.

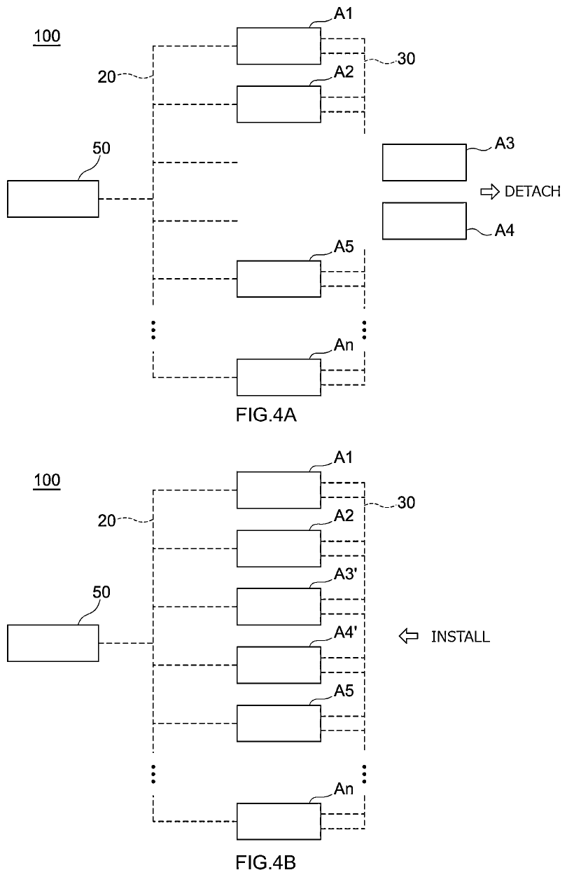

As shown in FIGS. 4A and 4B, among the plurality of battery modules A1 to An, for example, the battery module A3 is replaced with the battery module A3′, and the battery module A4 is replaced with the battery module A4′. In this case, by a manager or the like who manages the battery system 100, the battery module A3′ and the battery module A4′ are connected to the communication line 20 and the activation control line 30. With this, the plurality of battery modules A1 to An constituting the battery system 100 recognize that the battery module A3 has been replaced with the battery module A3′ and the battery module A4 has been replaced with the battery module A4′, and the procedure shown in FIG. 3 is started. Note that, as described above, in the case of the replacement with the battery module A3′ and the battery module A4′, the other battery modules A1 to An which are not replaced have the identifiers which are already set, and have transmitted the set identifiers of the arithmetic processing units 40 (S15 to S18 described later).

In Step S10 in FIG. 3, the activation control section 44 of the arithmetic processing unit 40 of the battery module A3′ determines whether or not the IG signal ON is input via the activation control line 30. When the IG signal ON is input, the arithmetic processing unit 40 starts the identifier setting processing. In the case where the IG signal ON is input (S10: YES), the processing proceeds to Step S11. Note that the IG signal is configured to be input to, e.g., the battery module A1 at a stage in which the identifier setting processing is started, and be sequentially input to the subsequent battery modules.

On the other hand, in the case where the IG signal ON is not input (S10: NO), the processing waits until the IG signal ON is input.

In Step S11, the identifier setting section 42 determines whether or not the identifier of the arithmetic processing unit 40 is set. As described above, in the case where the replacement is performed, the identifier is not set in the battery module A3′ having replaced the battery module A3 (S11: YES), and hence the processing proceeds to Step S12. Herein, that the identifier is not set denotes a state in which the identifier of the arithmetic processing unit 40 is not stored in the identifier storage section 45, and the identifier setting section 42 cannot read the identifier of the arithmetic processing unit 40. Note that there may be cases where the battery module A3′ having replaced the battery module A3 has already been used in another battery system and, as a result, an invalid identifier is set in the identifier storage section 45. In these cases, it is preferable to execute the identifier setting processing after performing initialization processing via the communication line 20. The initialization processing may be appropriately performed by, e.g., the manage or the like.

In Step S12, the monitoring section 43 monitors the communication line 20 for the predetermined time period. Herein, the time period in which the monitoring section 43 monitors the communication line 20 only needs to be longer than the time interval at which the other battery modules communicate the identifiers, and it is possible to appropriately adjust the predetermined time period, as described above.

As described above, the other battery modules A1 to An which are not replaced have transmitted the set identifiers of the arithmetic processing units 40, and hence the monitoring section 43 of the battery module A3′ can receive the identifiers from the other battery modules A1 to An which are not replaced. On the other hand, the identifier is not set in the battery module A4′ having replaced the battery module A4, and hence the battery module A4′ does not transmit the identifier of the arithmetic processing unit 40. In Step S13, the activation control section 44 of the battery module A3′ outputs the IG signal OFF to the activation control line 30 so as to stop the identifier setting processing of another battery module (herein, the battery module A4′) which has not transmitted the identifier. With this, the identifier setting processing of the battery module A4′ is temporarily stopped. That is, even in the case where a plurality of the battery modules are replaced at the same time, while the battery module (herein, the battery module A3′) to which the IG signal ON is input first executes the identifier setting processing, the identifier setting processing is executed in the other battery module (herein, the battery module A4′), and it is possible to prevent setting of a duplicate identifier in a plurality of the battery modules.

In Step S14, the identifier setting section 42 of the battery module A3′ sets the identifier which is different from the identifier acquired when the monitoring section 43 monitors the communication line 20 as the identifier of the arithmetic processing unit 40. In one aspect, among the identifiers which can be set, the lowest identifier number is preferably set as the identifier of the arithmetic processing unit 40. Herein, for example, when the identifier of the battery module A1 is set to “ID1”, the monitoring section 43 of the battery module A3′ receives, e.g., CANID101 corresponding to ID1 as the identifier. Similarly, when the identifier of the battery module A2 is set to “ID2” and the identifier of the battery module A5 is set to “ID5”, the monitoring section 43 of the battery module A3′ receives CANID201 corresponding to ID2 and CANID501 corresponding to ID5. Consequently, the identifier setting section 42 of the battery module A3′ may appropriately set “ID3” as the identifier of the arithmetic processing unit 40. The set identifier is stored in the identifier storage section 45 as the identifier of the arithmetic processing unit 40. With this, in the case where the battery module A3 is replaced with the battery module A3′, it is possible to transfer various pieces of information set to be associated with the identifier to the battery module A3′, and perform the replacement of the battery module easily.

Note that, herein, a description will be given of the case where, as a result of monitoring the communication line 20 for the predetermined time period by the monitoring section 43 in Step S12, the identifier is not received. In the case where the identifier is not received, the activation control section 44 outputs the IG signal OFF to the activation control line 30 so as to stop ally of a plurality of the battery modules. With this, the identifier setting processing in all of the battery modules which have not transmitted the identifiers is temporarily stopped. In the case where the identifier is not received, it is possible to determine that the identifier which is already set (used) in, among a plurality of the battery modules, the other battery modules is not present. Accordingly, the identifier setting section 42 sets any identifier as the identifier of the arithmetic processing unit 40. For example, the lowest identifier number (e.g., “ID1”) is preferably set as the identifier of the arithmetic processing unit 40. The set identifier is stored in the identifier storage section 45 as the identifier of the arithmetic processing unit 40.

In Step S15, the identifier setting section 42 of the battery module A3′ transmits the identifier (herein, CANID301 corresponding to ID3) set as the identifier of the arithmetic processing unit 40 to the communication line 20 via the communication section 41. A transmission method is not particularly limited, and the identifier may be transmitted preferably at time intervals of, e.g., 100 milliseconds. In Step S16, the activation control section 44 of the battery module A3′ outputs the IG signal ON to the activation control line 30. The IG signal ON transmitted herein starts the identifier setting processing of the battery module, as described above. With this, the identifier setting processing of the battery module A4′ is started. That is, it is possible to activate, among a plurality of the battery modules, the battery module which has not transmitted the identifier (i.e., the identifier is not set) to start the identifier setting processing.

Note that the identifier of the battery module A4′ is set by executing the same steps as the identifier setting processing steps of the battery module A3′.

In the identifier setting system having the above-described configuration, in the case where the identifier is not set in the battery module which is one of a plurality of the battery modules and it is necessary to execute the identifier setting processing, the identifier setting processing of another battery module which has not transmitted the identifier is temporarily stopped. With this, when the identifier setting processing is executed in the battery module which is one of a plurality of the battery modules, the identifier setting processing is not executed concurrently in the other battery module. Therefore, it is possible to prevent the setting of the duplicate identifier in the battery system. In addition, while the identifier setting processing is executed in the battery module which is one of a plurality of the battery modules, the identifier setting processing of the other battery module in which the identifier is not set is stopped, and hence it is possible to save power consumption.

A description will be given of the case where, on the other hand, the identifier is already set (S11: NO) in the flowchart in FIG. 3. The identifier setting processing can be processing which is executed in the battery module (e.g., the battery module A2 shown in FIG. 4B) which is not replaced in the case where, e.g., the battery module A3 is replaced with the battery module A3′ and the battery module A4 is replaced with the battery module A4′. Note that that the identifier is already set denotes a state in which the identifier of the arithmetic processing unit 40 is already stored in the identifier storage section 45, and the identifier setting section 42 can read the identifier of the arithmetic processing unit 40.

In the case where the identifier is already set (S11. NO), the processing proceeds to Step S17. In Step S17, the identifier setting section 42 of the battery module A2 reads the identifier of the arithmetic processing unit 40 from the identifier storage section 45. Next, in Step S18, the identifier setting section 42 of the battery module A2 sets the read identifier as the identifier (herein, ID2) of the arithmetic processing unit 40. The set identifier is stored in the identifier storage section 45 as the identifier of the arithmetic processing unit 40. Subsequently, the processing proceeds to Step S15. The subsequent processing is identical to the processing described above, and hence the description thereof will be omitted.

As described above, according to the identifier setting system disclosed herein, in the case where the identifier is already set in the arithmetic processing unit, it is possible to set the read identifier as the identifier of the arithmetic processing unit, and it is possible to transmit the identifier to the communication line 20. Then, the identifier setting system disclosed herein outputs the IG signal ON to the activation control line 30 so as to activate the other battery module, and starts the identifier setting processing.

While the specific examples of the present disclosure have been described in detail thus far, the specific examples are only illustrative, and are not intended to limit the scope of claims. The technique described in the scope of claims encompasses various modifications and changes to the specific examples described above. For example, part of the embodiment described above can be replaced with another modification, and another modification can be added to the embodiment described above. In addition, if technical features are not described as essential, they can be appropriately deleted.

For example, in the embodiment, as an example of control which uses the activation line, the description has been given of the configuration in which the activation of, among a plurality of the battery modules, the other battery module is controlled by outputting the IG signal ON to the activation control line 30. However, the method of the control which uses the activation line is not limited thereto. For example, a power supply line is connected such that power can be supplied to the plurality of battery modules A1 to An, and the activation of the other battery module may be controlled by controlling the power supply line. Specifically, in the case where the identifier of the arithmetic processing unit is not set, the above-described activation control section 44 temporarily stops the supply of power from the power supply line to, among a plurality of the battery modules, the other battery module. By such processing, it is possible to stop the other battery module having the same configuration. Subsequently, after the above identifier setting processing is executed, power is supplied from the power supply line such that, among a plurality of the battery modules, the other battery module is activated. By such processing, it is possible to activate the other battery module. With this, in the battery system having a plurality of the battery modules, when the identifier setting processing is executed in the battery module which is one of a plurality of the battery modules, the identifier setting processing is not concurrently performed in the other battery module. Then, it is possible to prevent the setting of the duplicate identifier in the battery system.

What is claimed is:

1. An identifier setting system comprising:
a plurality of control devices;
a communication line which connects the plurality of control devices such that the plurality of control devices can communicate with each other; and
an activation line which connects the plurality of control devices such that activations of the plurality of control devices can be mutually controlled, wherein
each of the plurality of control devices includes:
a communication section which is configured to be able to communicate with the communication line;
a monitoring section which monitors the communication line;
an identifier setting section which sets an identifier; and
an activation control section which controls the activation of the control device, and wherein
in a case where the identifier setting section of a control device, which is one of the plurality of control devices, determines that an identifier of the control device is not set, the monitoring section monitors the communication line for a predetermined period of time to acquire identifiers output from the plurality of control devices, and the activation control section controls the activation line so as to stop another control device, which does not output the identifier,
the identifier setting section sets an identifier different from the identifiers acquired by the monitoring section by monitoring the communication line for the predetermined period of time as the identifier of the control device, and the activation control section controls the activation line so as to activate the other control device, which does not output the identifier.

2. The identifier setting system according to claim 1, wherein
in a case where the identifier setting section of the control device, which is one of the plurality of control devices, determines that the identifier of the control device is already set, the identifier setting section outputs the identifier of the control device to the communication line, and
the activation control section controls the activation line so as to activate the other control device, which is one of the plurality of control devices.
